(19) United States
(12) Patent Application Publication
(10) Pub. No.: US 2026/0355760 A1
(43) Pub. Date: Nov. 12, 2026

(54) GUN AND LIGHTING MODULE COMPRISING REAR COVER WITH LIGHTING FUNCTION FOR POWDER PAINT APPLICATIONS

(71) Applicant: SISTEM TEKNIK MAKINA SANAYI VE TICARET ANONIM SIRKETI, Izmir (TR)

(72) Inventors: Serdar KAYA, Izmir (TR); Deniz TÜRKÜN, Izmir (TR)

(21) Appl. No.: 19/115,399

(22) PCT Filed: Nov. 21, 2024
(86) PCT No.: PCT/TR2024/051380

§ 371 Date: Mar. 26, 2025

(30) Foreign Application Priority Data
Nov. 24, 2023 (TR) 2023/015690

(51) Int. Cl. B05B 5/03; B05B 15/00; F21V 33/00

(52) U.S. Cl. CPC B05B 5/032; B05B 15/00; F21V 33/0084

(57) ABSTRACT

Disclosed is a gun for use in the powder coating industry having a power cable providing energy connection, a connection socket at the end of the power cable, an electronic card, a rear cover, a compression nut and a flexible element providing sealing, and a lighting module integrated into the powder coating gun to provide light to the operator during powder coating application.

### TECHNICAL FIELD

The invention relates to a powder paint gun comprising rear cover with a lighting function and a lighting module integrated into the gun, used in areas where manual application will be made in the powder paint coating industry.

### STATE OF ART

In powder painting works applied with a gun, the powder paint is first electrostatically charged during the process of passing through the gun and thus the powder particles adhere directly to the product to be painted. In this way, the coating process is performed. In manual powder painting processes, it is important for the operator to see the area to be painted clearly. External light sources can be used to achieve this. In addition to external light sources, there are also illuminated powder paint guns that provide easier use.

In the powder coating guns in the present art, the lighting apparatus is positioned in the area where the gun hanger is used. In this case, the function of the gun hanger is reduced and the hanging of the gun becomes difficult. In some guns, it is seen that the lighting apparatus is placed on the front of the gun. In this case, the placed light does not have a function that will contribute to the use of the gun other than illumination.

As a result of a search carried out in the state of the art, application numbered U.S. Pat. No. 10,539,318 B2 was encountered. Said application describes a light assembly connected to a spray gun for spraying electrostatically charged coating material. Here, the lighting apparatus is placed on the upper part of the body of the powder coating gun. The apparatus placed has no function other than lighting that will contribute to the use of the gun.

As a result, improvements are being made to the lighting modules in guns with lighting functions for powder coating applications, therefore new structures are needed that will eliminate the disadvantages mentioned above and provide solutions to existing systems.

### OBJECT OF THE INVENTION

The invention relates to a gun comprising a rear cover with lighting function and a lighting module integrated into the rear cover for powder coating applications, which meets the above-mentioned requirements, eliminates all disadvantages and brings some additional advantages.

The rear cover mentioned in the invention and integrated into the powder coating gun is characterized by comprising the user interface that enables the operation of the lighting module and by performing the hanger function when the gun is desired to be hung somewhere with a protrusion included in the rear cover body.

An object of the invention is to enable the cable to be taken out of the gun by means of the cable channel and cable space it contains, thus enabling the lighting module to be easily removed and installed.

The structural and characteristic features of the invention and all its advantages will be understood more clearly by means of the drawings given below and the detailed description written by making references to these drawings. Therefore, the evaluation needs to be made by taking these drawings and detailed description into consideration.

### BRIEF DESCRIPTION OF THE DRAWINGS

In order to best understand the structure of the present invention and its advantages together with the additional elements, it should be evaluated together with the drawings described below.

FIG. 1 is the disassembled view of the gun rear cover, which comprises a rear cover with lighting function for powder paint applications, which is the subject of the invention.

FIG. 2 is the perspective view of the rear cover of the gun, which comprises a rear cover with illumination function for powder paint applications, which is the subject of the invention.

FIG. 3 is the A-A sectional view of the rear cover of the gun, which comprises a rear cover with illumination function for powder paint applications, which is the subject of the invention.

FIG. 4 is the perspective view of the lighting module in guns, which comprise a lighting function rear cover for powder paint applications, which is the subject of the invention.

FIG. 5 is the side view of the lighting module in guns, which comprise a lighting function rear cover for powder paint applications, which is the subject of the invention.

FIG. 6 is the B-B sectional view of the lighting module in guns, which comprise a lighting function rear cover for powder paint applications, which is the subject of the invention.

FIG. 7 is the side view of the gun, which comprises a rear cover with lighting function for powder paint applications, which is the subject of the invention.

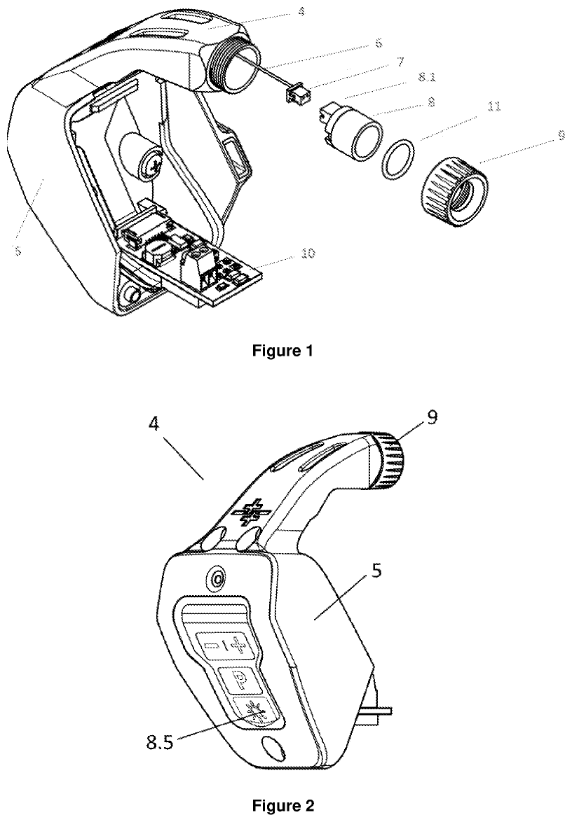

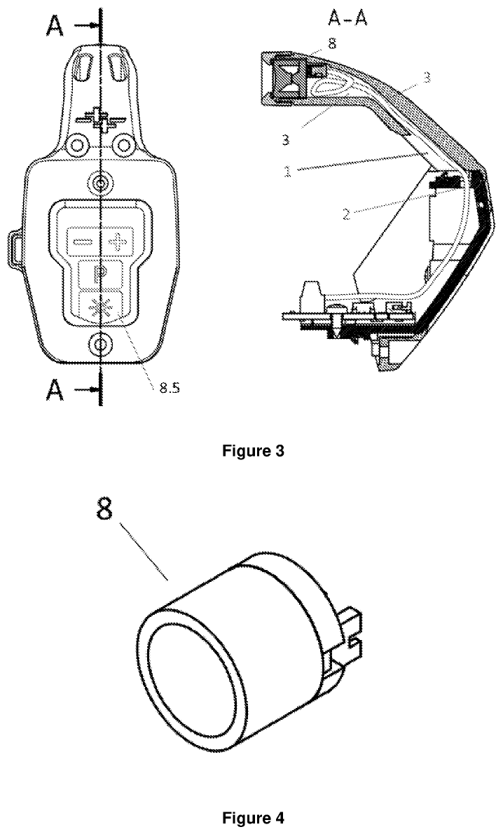

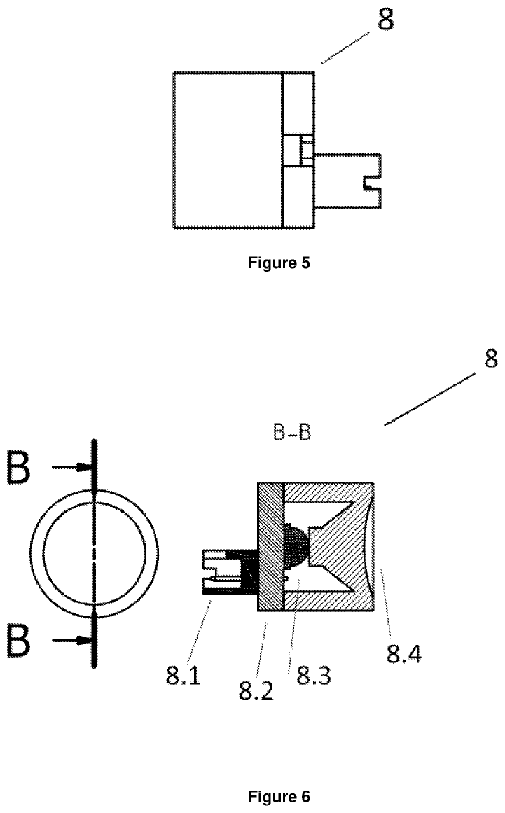

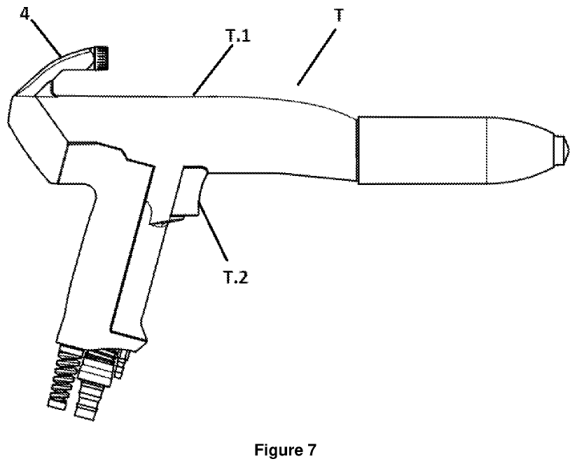

### REFERENCE NUMBERS

1. Cable channel
2. Through hole
3. Cable space
4. Rear cover
5. Rear cover body
6. Power cable
7. Connection socket
8. Lighting module
8.1. Power connector
8.2. Light electronic card
8.3. Light source
8.4. Lens
8.5. Turn on/off switch
9. Compression nut
10. Electronic card
11. Flexible element
T. Gun
T.1 Gun body
T.2 Gun trigger

### DETAILED DESCRIPTION OF THE INVENTION

In this detailed description, the preferred embodiments of a gun (T) and a lighting module (8), which are the subject of the invention are descried only for the purpose of a better understanding of the subject and in a way that does not form any limiting effects.

The gun (T) mentioned in the invention comprises a rear cover (4), a gun body (T.1) and a gun trigger (T.2).

The invention is a powder paint gun (T) comprising a power cable (6) that provides energy connection, a connection socket (7) at the end of the power cable (6), an electronic card (10), a rear cover (4) that includes a flexible element (11) that provides sealing, and the lighting module (8) integrated into the rear cover (4) to provide light to the operator during powder paint application, used in areas where manual application will be made in the powder paint industry,
The rear cover (4) comprises:
   A cable channel (1) that provides the route of the power cable (6) inside the gun (T),
   A through hole (2) that allows the power cable (6) from the electronic card (10) to reach the cable channel (1),
   A cable space (3) that allows the power cable (6) to be stacked inside the gun (T) to be removed when necessary,
   A compression nut (9) which, when turned clockwise, compresses the lighting module (8) and ensures that the lighting module (8) is inside the rear cover (4), and when turned counterclockwise, unscrews the lighting module (8) and ensures that the lighting module (8) comes out of the rear cover (4),
   A turn on/off switch (8.5) and
The lighting module (8) comprises:
   a power connector (8.1) that receives the energy carried by the power cable (6) by connecting to the connection socket (7),
   a light electronic card (8.2) that provides light to the lighting module (8) with the command it receives from the electronic card (10),
   a light source (8.3) that starts simultaneously with the spraying of powder paint when the gun trigger (T.2) is pressed and ends when the gun trigger (T.2) is released or provides more light after a while after the trigger is released,
   a lens that enables the light (8.4) to focus.

The lighting module (8), which is the subject of the invention, can be operated in various ways for different purposes using the gun trigger (T.2) and the user interface. The working principle of the lighting module (8) is basically as follows; while spraying is being performed with an electrostatic powder paint gun, a light beam comes out from the lighting function gun hanger and a lighting area is formed on the work piece and the work piece is illuminated. The illumination process starts simultaneously with the spraying of powder paint when the gun trigger (T.2) is pressed and ends when the gun trigger (T.2) is released and/or the light source (8.3) located on the rear cover (4) of the gun with illumination function continues to illuminate the work piece for a while after the gun trigger (T.2) is released. In cases where the lighting function is desired to operate continuously, the lighting produced by the light source (8.3) located on the rear cover (4) of the gun with lighting function starts when the operator presses the turn on/off switch (8.5) on the user interface and ends automatically after a while or is terminated by the operator pressing the turn on/off switch (8.5).

The lighting module (8) integrated into the gun (T) and the rear cover (4), which are subject of the invention enables the power cable (6) to be taken out of the gun (T) by means of the cable channel (1) located inside the rear cover (4) and the cable space (3) located behind the lighting module (8), thus enabling the lighting module (8) to be easily removed and installed. In addition, the light source (8.3) can be applied to any part of the gun body (T.1), with priority given to the rear cover (4) of the gun.

1. A powder paint gun comprising a power cable that provides energy connection, a connection socket at the end of the power cable, an electronic car, a rear cover that includes a flexible element that provides sealing, and a lighting module integrated into the rear cover to provide light to the operator during powder paint application, wherein comprising:
the rear cover comprises:
a cable channel that provides the route of the power cable inside the gun;
a through hole that allows the power cable from the electronic card to reach the cable channel; and
a compression nut which, when turned clockwise, compresses the lighting module and ensures that the lighting module is inside the rear cover 4, and when turned counterclockwise, unscrews the lighting module and ensures that the lighting module comes out of the rear cover; and
wherein the lighting module comprises:
a power connector that receives the energy carried by the power cable by connecting to the connection socket;
a light electronic card that provides light to the lighting module with the command it receives from the electronic card;
a light source that starts simultaneously with the spraying of powder paint when the gun trigger is pressed and ends when the gun trigger is released or provides more light after the gun trigger is released; and
a lens that enables the light to focus.

2. A gun and a lighting module integrated into the rear cover to provide light to the operator during powder coating application according to claim 1, wherein the gun comprises a cable space that allows the power cable to be stacked inside the gun to be taken out when necessary.

3. A gun and a lighting module integrated into the rear cover to provide light to the operator during powder coating application according to claim 1, wherein the rear cover comprises a turn on/off switch located on it.
